(19) United States
(12) Patent Application Publication
(10) Pub. No.: US 2015/0186317 A1
(43) Pub. Date: Jul. 2, 2015

(54) METHOD AND APPARATUS FOR DETECTING THE INITIATOR/TARGET ORIENTATION OF A SMART BRIDGE

(71) Applicant: LSI Corporation

(72) Inventors: Reid A. Kaufmann, Wichita, KS (US); Jason A. Unrein, Wichita, KS (US); Luiz D. Varchavtchik, Wichita, KS (US)

(73) Assignee: LSI Corporation

(21) Appl. No.: 14/146,486

(22) Filed: Jan. 2, 2014

(51) Int. Cl. G06F 13/40

(52) U.S. Cl. CPC G06F 13/4027; G06F 13/4068

(57) ABSTRACT

Methods and systems are provided for adaptive interconnect bridging. A first interconnect type may be determined for a first bridging interface, which is configurable to support a first plurality of interconnect types; and a second interconnect type may be determined for a second bridging interface that is configurable to support a second plurality of interconnect types. The first bridging interface may then be configured based on the first interconnect type, and the second bridging interface may then be configured based on the second interconnect type. Further, the orientation of bridging may be configured based on the determined interconnect types as well as on functions of devices attached to the first bridging interface and the second bridging interface. One of the first bridging interface and the second bridging interface may be assigned a function of ‘initiator’ whereas the other one of the first bridging interface and the second bridging interface a function of ‘target’.

### TECHNICAL FIELD

Aspects of the present application relate to computer devices or systems. More specifically, certain implementations of the present disclosure relate to a method and apparatus for detecting the initiator/target orientation of a smart bridge.

### BACKGROUND

Existing methods and systems for providing interconnect based bridging in computing devices or systems may be inefficient and/or costly. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for detecting the initiator/target orientation of a smart bridge, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF THE DRAWINGS

FIG. 1 illustrates an example electronic system incorporating use of an interconnect bridge between two different interfaces.

FIG. 2 illustrates an example bridge device that support adaptive configured of two different interfaces.

FIGS. 3A and 3B illustrate examples for adaptive configuration of interfaces in a bridge device, based on orientation and interconnect type.

FIG. 4 is a flowchart illustrating an example process for adaptive configuration of an interface in a bridge device, based on orientation and interconnect type.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

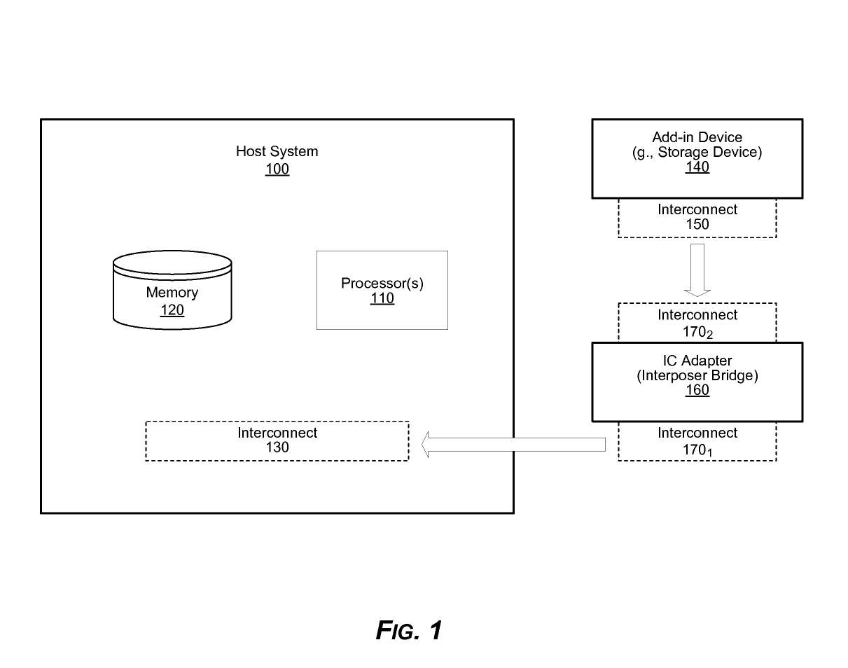

FIG. 1 illustrates an example electronic system incorporating use of an interconnect bridge between two different interfaces. Referring to FIG. 1, there is shown a host system 100, an add-in device 140, and interconnect (IC) adapter 160.

The host system 100 comprises suitable circuitry for implementing various aspects of the present disclosure. For example, the host system 100, as used herein, may comprise suitable circuitry configured for performing or supporting various functions, operations, applications, and/or services. The functions, operations, applications, and/or services performed or supported by the host system 100 may be run or controlled based on user instructions and/or pre-configured instructions. Examples of systems that may correspond to the host system 100 may comprise computers (e.g., desktops, laptops, servers, and workstations) and the like. The disclosure, however, is not limited to any particular type of systems.

The host system 100 comprises, for example, one or more processors 110, a system memory 120, and a plurality of other hardware/software (HW/SW) resources (e.g., input/output devices, drivers, operating system(s), applications, etc.). In this regard, each processor 110 may comprise suitable circuitry for processing data, for executing or running particular services, tasks and/or applications, and/or for controlling and/or managing operations (e.g., of other components in the host system 100). For example, the processor(s) 110 may configure and/or control operations of various components and/or subsystems of the host system 100, by utilizing, for example, one or more control signals. Further, processor(s) 110 may also enable running and/or execution of applications, programs and/or code, which may be stored, for example, in the system memory 120. The processor(s) 110 may comprise general purpose or special purpose processors. The system memory 120 may comprise suitable circuitry for providing permanent and/or non-permanent storage, buffering, and/or fetching of data, which may be used, consumed, and/or processed in the host system 100. In this regard, the system memory 120 may comprise different memory technologies, including, for example, read-only memory (ROM), random access memory (RAM), Flash memory, solid-state drive (SSD), and/or field-programmable gate array (FPGA). The system memory 120 may store, for example, configuration data, which may comprise parameters and/or code, comprising software and/or firmware.

In some instances, some systems (e.g., the host system 100) may incorporate use of interconnects. In this regard, interconnects may be utilized as backplane interconnect (i.e., within the system, such as motherboard interconnect) as well as expansion interface (to allow attachment of add-in devices). Thus, interconnects may provide physical medium (e.g., comprising electrical connectors and/or slots) as well as communication supported therein (e.g., signaling), based on particular interconnect/interface protocols, for facilitating connection to and communication with various types of components (e.g., network cards) or devices (e.g., storage devices). As mentioned, such connectivity may include both internal components of the systems as well as add-in devices (internal or external) for providing additional/particular services or functions. For example, the host system 100 may comprise an interconnect 130. The interconnect 130 may comprise suitable circuitry for providing interconnect functionality in the host system 100. The interconnect 130 may comprise, for example, suitable physical components (e.g., a printed circuit board with suitable connectors, ports, and/or slots), and/or related software/firmware. Accordingly, the interconnect 130 may be configured to provide a backplane as well as expansion interface—e.g., for allowing attachment of components, additional boards, and/or devices. For example, the interconnect 130 may be used, for example, to enable attachment of processing resources and/or storage devices (internally or externally).

The device 140 comprises an electronic device (or component) that may be attached to systems, such as the host system, to provide a particular function or service. The device 140 may comprise, for example, a mass storage device that may be added to the host system 100 to provide storage (e.g., in lieu of or in conjunction with existing storage resources, such as the memory system 120). The device 140 may be configured for interconnect based use—i.e., such that it may be added to a system by being plugged or attached to interconnect thereof. For example, the device 140 may incorporate an interconnect 150, which may be configured to support particular types of connectors that may be used when the device 140 is added (e.g., to systems such as the host system 140).

In some instances, types of interconnects for intended systems (e.g., the host system 100) and intended add-in components or devices may differ. For example, the interconnect 130 may be used to provide connectivity to storage devices based on Serial Attached SCSI (SAS)/Serial Advanced Technology Attachment (SATA) configuration. One the other hand, the interconnect 150 of the device 140 may be Peripheral Component Interconnect Express (PCIe) based (e.g., the interconnect 150 may comprise a PCIe connector intended to be used for attachment by receiving a device into a PCIe slot). In this regard, many existing systems use SAS/SATA based configuration for storage interfacing. However, many of the attached (add-in) storage devices currently entering the market are PCIe based, resulting in incompatibility issues.

Accordingly, in some instances it may be necessary to use interconnect adaptors, which would allow connecting different types of connectors (and/or protocols based thereon). For example, the IC adapter 160 may be utilized resolve possible interconnect mismatches between the add-in device 140 and the host system 100.

The IC adapter 160 comprises suitable circuitry for supporting and/or resolving interconnect mismatch. In this regard, the IC adapter 160 may be configured to support different types of interconnects. For example, the IC adapter 160 may comprise two interconnects 170₁ and 170₂, corresponding to two different types of interconnects (i.e., each incorporating particular types of connectors and support for handling signaling used therefor in accordance with particular protocol(s) corresponding thereto). Further, the IC adapter 160 may be operable to perform necessary bridging (or interposing) functions required to forward data through the two different types of interconnects corresponding to interconnects 170₁ and 170₂. In the example scenario shown in FIG. 1, the types of interconnects 170₁ and 170₂ may correspond to the types of interconnects 130 (of the host system 100) and 150 (of the add-in device 140), respectively. Thus, the IC adapter 160 may be used to facilitate addition of the device 140, by attaching it the IC adapter 160 (using the device interconnect 150 and the IC adapter interconnect 170₁), and then attaching the IC adapter 160 to the host system interconnect 130 (using the IC adapter interconnect 170₂).

While use of fixed type adapters (i.e., only supporting one particular type of interconnect on particular side, and only supporting bridging in particular orientation—i.e., with the host-side being fixed to particular side, and the add-in device being fixed to the other) may resolve certain interconnect mismatch situations (only those corresponding to the arrangement of the fixed adapter), it may be desirable to provide (e.g., to server vendors, system integrators, and cloud data center architects) solutions with an added measure of flexibility (particularly during transitional periods between different interconnect technologies). For example, rather than use fixed dual-type adapters, it may be desirable to provide adaptive solutions which may support multiple types of interconnects, and to do so regardless of their interface (i.e., on either side). Thus, the same adapter can be used in different situations—i.e., for different interconnect mismatch scenarios. Examples implementations of adaptive interconnect bridging is described in more detail with respect to the following figures.

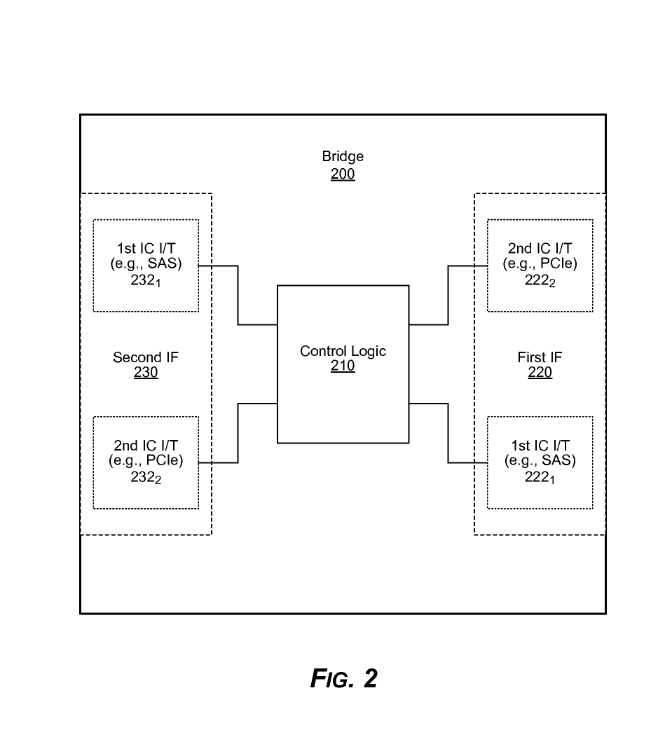

FIG. 2 illustrates an example bridge device that supports adaptive configuration of two different interfaces. Referring to FIG. 2, there is shown a bridge device 200.

The bridge device 200 comprises suitable circuitry for providing bridging between different types of interfaces—e.g., corresponding to different types of interconnects, and to specifically do so in an adaptive manner. For example, the bridge device 200 may be used to enable attaching devices (internally or externally) to a host system when the two peers (i.e., the attached device and the host system) support or use different types of interconnects. The bridge device 200 may enable adaptive configuration and/or use, such as to enable setting direction of bridging between devices having different functions, using any interconnect (or interface) supported by the bridge device 200, based on the different functions. For example, the bridge device 200 can be used to bridge between initiator and target (or master or slave) devices with the initiator being connected to any of the interconnects supported by the bridge device 200. The bridge device 200 may correspond, for example, to the IC adapter 160 of FIG. 1 (when implemented in adaptive manner).

As shown in the example implementation depicted in FIG. 2, the bridge device 200 may comprise control logic 210, a first interface component 220, and second interface component 230. Each of the first interface component 220 and the second interface component 230 may comprise circuitry for providing interfacing operations based on one or more types of interconnects. In this regard, each of the first interface component 220 and the second interface component 230 may incorporate one or more interface elements, with each interface element being configured to support a particular type of interconnect. For example, each interface element may comprise physical connectivity related parts (e.g., connector plugs, ports, and/or slots) corresponding to particular interface/interconnect protocol (e.g., PCIe, SAS/SATA, etc.) along with corresponding circuitry for providing the necessary processing functions—e.g., to facilitate reception or transmission of signals in accordance with the protocols. In the example implementation shown in FIG. 2, each of the first interface component 220 and the second interface component 230 may comprise two interface elements—that is interface elements 222₁ and 222₂ in the first interface component 220, and interface elements 232₁ and 232₂ second interface component 230. These interface elements may be configured to support SAS/SATA based interconnect/interfacing (interface elements 222₁ and 232₁) and PCIe based interconnect/interfacing (interface elements 222₂ and 232₂), respectively.

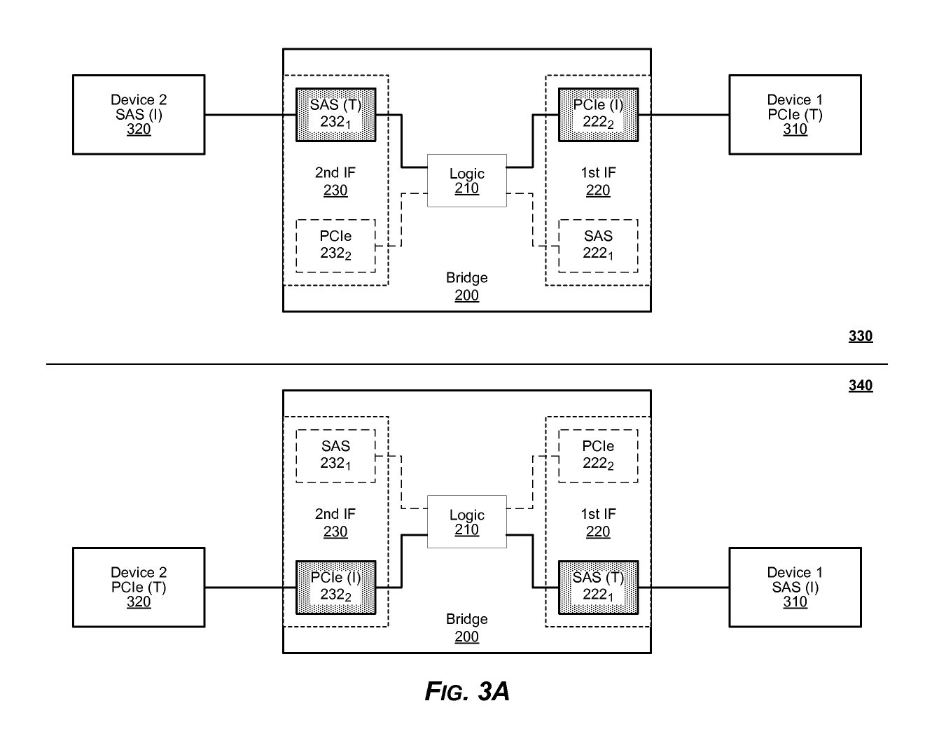

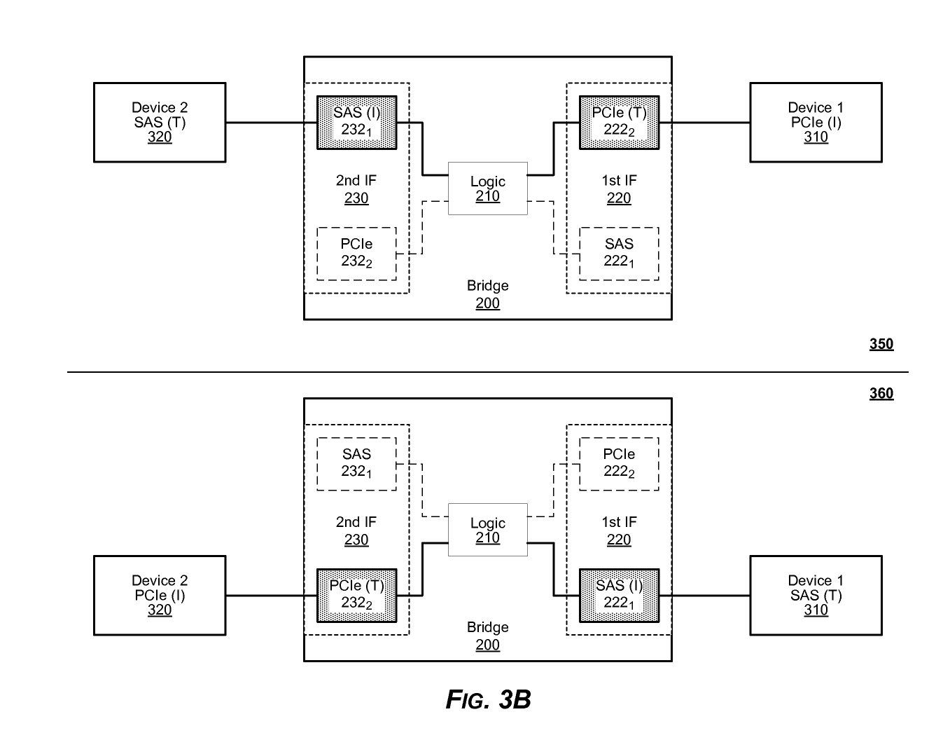

The control logic 210 comprises circuitry for controlling operations of the bridge device 200, particularly bridging operations performed therein. For example, the control logic 210 may provide connectivity (within the chip) between the first interface component 220, and second interface component 230, particularly in a manner that enables connectivity between different components thereof corresponding to different types (e.g., of interconnect). Accordingly, the control logic 210 may be used in providing adaptive configuration of the bridge device 200, by activating particular interface elements of the interface components. Examples of adaptive configuration of the bridge device 200, in accordance with the present disclosure, are described in more detail with respect to FIGS. 3A and 3B.

FIGS. 3A and 3B illustrate examples for adaptive configuration of interfaces in a bridge device, based on orientation and interconnect type. Referring to FIGS. 3A and 3B, there is shown the bridge device 200 of FIG. 2. Also shown in FIGS. 3A and 3B are devices device_1 310 and device_2 320.

The device_1 310 and the device_2 320 may correspond to any suitable devices (or system components) that may be attached using the bridge device 200. For example, one of the device_1 310 and the device_2 320 may correspond to a ‘host system’ and the other may correspond to an ‘add-in’ device or component being attached thereto. Thus, each of the device_1 310 and the device_2 320 may have a different function (e.g., one may be an ‘initiator’ while the other may be a ‘target’). Further, in some instances, each of the device_1 310 and the device_2 320 may support or use a different interconnect technology (e.g., one may use a PCIe based interconnect while the other may use a SAS/SATA based interconnect). Accordingly, FIGS. 3A and 3B depict different adaptive configurations of the bridge device 200, for different use scenarios (e.g., scenarios 330, 340, 350, and 360) corresponding to differences in function and type of interconnect technologies used by each of the two devices attached to either of the interface-sides of the bridge device 200.

For example, in the first scenario 330, shown in FIG. 3A, the device_1 310 may use a PCIe based interconnect, whereas the device_2 320 may use a SAS/SATA based interconnect. Further, the device_2 320 may function as an initiator (e.g., be a storage host system), and the device_1 310 may function as the target (e.g., be a storage add-in device). This information may be obtained by the control logic 210—e.g., determined autonomously, such as based on the particular connector used in either side (i.e., to which the device attaches or is plugged), and/or based on signaling received from the devices (e.g., through the connectors or by any other suitable means). The control logic 210 may then adaptively configure the bridge device 200 based on that information. For example, the control logic 210 may activate only the PCIe interface element 222₂ of the first interface component 222 (since the corresponding device attached thereto, the device_1 310, uses PCIe), and may activate only the SAS interface element 232₁ of the second interface component 232 (since the corresponding device attached thereto, the device_2 320, uses SAS/SATA).

The control logic 210 may also configure the activated interface elements based on functions of the devices attached thereto (e.g., such that the interface elements simulate functions of expected peers). For example, the control logic 210 may configure the PCIe interface element 222₂ to function as initiator (I), since the corresponding device attached thereto, the device_1 310, is functioning as target, and may configure the SAS interface element 232₁ to function as target (T), since the corresponding device attached thereto, the device_2 320, is functioning as initiator.

Further, during bridging operations (i.e., when forwarding data between device_1 310 and device_2 320), the control logic 210 may configure the bridge device 200 to provide the required interposing functions (i.e., converting data based on interconnect types used on each side). For example, the control logic 210, which may handle the routing of forwarded data, may be configured to convert PCIe based data received via the PCIe interface element 222₂ to SAS/SATA based data for outputting via the SAS interface element 232₁; and may convert SAS/SATA based data received via the SAS interface element 232₁ to PCIe based data for outputting via the PCIe interface element 222₂.

In the second scenario 340, shown in FIG. 3A, the device_1 310 may use a SAS/SATA based interconnect, whereas the device_2 320 may use a PCIe based interconnect. Further, the device_1 310 may function as the initiator, and the device_2 320 may function as the target. Once the control logic 210 obtains that information, it may adaptively configure the bridge device 200 based thereon. For example, the control logic 210 may activate only the SAS interface element 222₁ of the first interface component 222, since the device_1 310 uses SAS/SATA, and may activate only the PCIe interface element 232₂ of the second interface component 232, since the device_2 320 uses PCIe. As for the functions of the activated interface elements, the control logic 210 may configure the SAS interface element 222₁ to function as the target (T), since the device_1 310 is functioning as the initiator, and may configure the PCIe interface element 232₂ to function as the initiator (I), since the device_2 320, is functioning as the target. Further, during bridging operations the control logic 210 may be configured to provide the required interposing functions in the bridge device 200—e.g., convert PCIe based data received via the PCIe interface element 232₂ to SAS/SATA based data for outputting via the SAS interface element 222₁; and may convert SAS/SATA based data received via the SAS interface element 222₁ to PCIe based data for outputting via the PCIe interface element 232₂.

In the third scenario 350, shown in FIG. 3B, the device_1 310 may use a PCIe based interconnect, whereas the device_2 320 may use a SAS/SATA based interconnect. Further, the device_1 310 may function as the initiator, and the device_2 320 may function as the target. Once the control logic 210 obtains that information, it may adaptively configure the bridge device 200 based thereon. For example, the control logic 210 may activate only the PCIe interface element 222₂ of the first interface component 222 (since the device_1 310 uses PCIe), and may activate only the SAS interface element 232₁ of the second interface component 232 (since the device_2 320 uses SAS/SATA). As for the functions of the activated interface elements, the control logic 210 may configure the PCIe interface element 222₂ to function as the target (T), since the device_1 310 is functioning as the initiator, and may configure the SAS interface element 232₁ to function as the initiator (I), since the device_2 320, is functioning as the target. Further, during bridging operations the control logic 210 may be configured to provide the required interposing functions in the bridge device 200—e.g., convert PCIe based data received via the PCIe interface element 222₂ to SAS/SATA based data for outputting via the SAS interface element 232₁; and convert SAS/SATA based data received via the SAS interface element 232₁ to PCIe based data for outputting via the PCIe interface element 222₂.

In the fourth scenario 360, shown in FIG. 3B, the device_1 310 may use a SAS/SATA based interconnect, whereas the device_2 320 may use a PCIe based interconnect. Further, the device_1 310 may function as the target, and the device_2 320 may function as the initiator. Once it obtains that information, the control logic 210 may adaptively configure the bridge device 200 based thereon. For example, the control logic 210 may activate only the SAS interface element 222₁ of the first interface component 222 (since the device_1 310 uses SAS/SATA), and may activate only the PCIe interface element 232₂ of the second interface component 232 (since the device_2 320 uses PCIe). As for the functions of the activated interface elements, the control logic 210 may configure the SAS interface element 222₁ to function as the initiator (I), since the device_1 310 is functioning as the target, and may configure the PCIe interface element 232₂ to function as the target (T), since the device_2 320, is functioning as the initiator. Further, during bridging operations the control logic 210 may be configured to provide the required interposing functions in the bridge device 200—e.g., convert PCIe based data received via the PCIe interface element 232₂ to SAS/SATA based data for outputting via the SAS interface element 222₁; and convert SAS/SATA based data received via the SAS interface element 222₁ to PCIe based data for outputting via the PCIe interface element 232₂.

Accordingly, by supporting the two types of interconnects (PCIe and SAS/SATA) in each of the interface-sides, and by being configurable to reverse orientation of bridging (i.e., direction of interposing) if needed, the bridge device 200 may be adaptively configured to provide four different possible bridging arrangements (whereas this previously would have required four different fixed adapters). Another benefit is that the bridge device may be adaptively reconfigured (i.e., functionality of its element reconfigured), if needed, without the need to physically remove it and re-attach it.

While the examples described herein are based on support of two (of the same) types of interconnects in both interface sides of the bridge device 200, the disclosure is not so limited. Rather, in some implementations, different numbers of interconnects (as well as different types of interconnects) may be supported. Nonetheless, the logic control 210 may be used in all such implementations to ensure that orientation of bridging provided by the bridge device 200 is configured based on the attached-to interconnect and the functions of the attaching devices, in similar manner as described herein.

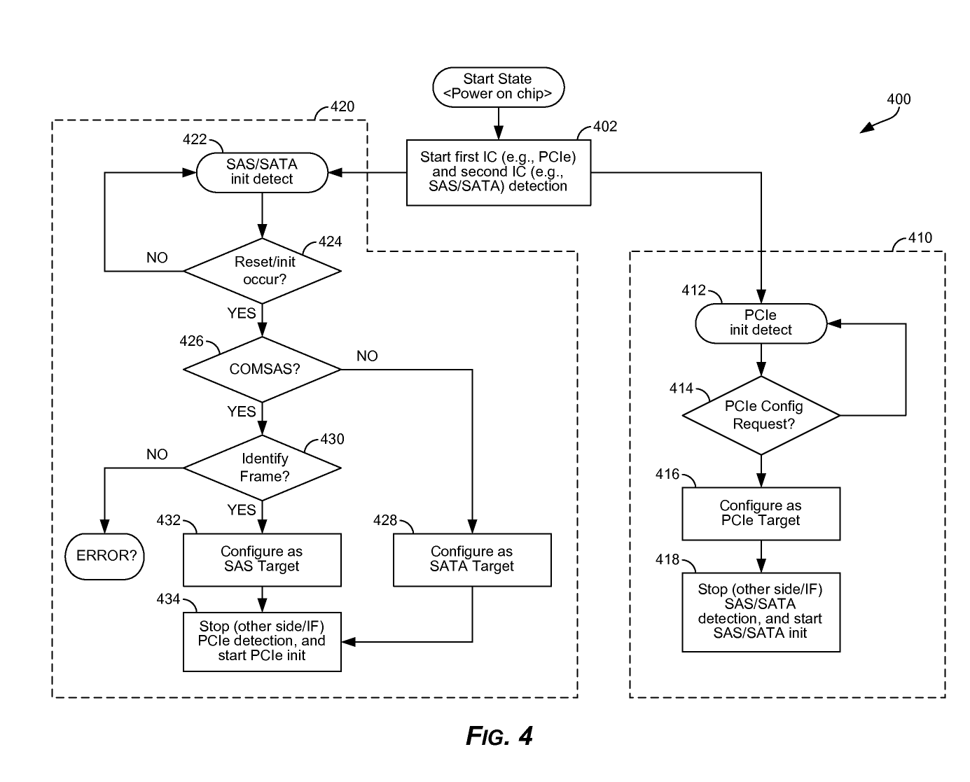

FIG. 4 is a flowchart illustrating an example process for adaptive configuration of an interface in a bridge device, based on orientation and interconnect type. Referring to FIG. 4, there is shown a flow chart 400, comprising a plurality of example steps, which may be performed in a bridge device (e.g., by control logic 210 of the bridge device 200) while an interface in the bridge device is adaptively configured (e.g., interface 220 or 230 in the bridge device 200).

In a starting step 402, a bridge device may be powered on or activated (e.g., by coupling it to host system and/or an add-in device). The bridge device may then attempt to determine, for both interface sides (e.g., interfaces 220 and 230 of bridge device 200) the interconnect to be used for the corresponding device being attached thereto, and also the orientation of the bridge device—e.g., determine on which side the ‘initiator’ and the ‘target’ devices are attached. Once the orientation is determined, both sides (interface components) of the bridge device may be configured accordingly—e.g., setting the interconnect functions on either side to mirror (i.e., be opposite of) that of the corresponding attached devices. Thus, in step 404, all interconnects supported in the bridge device are brought up and monitored—i.e., suitable detection functions corresponding to the support interconnect types may be run—to enable determining to which interface/interconnect the host is attached. For example, in the bridge device 200, which support PCIe and SAS/SATA based interconnects on each interface-side (i.e., in each of the interfaces 220 and 230), both PCIe and SAS/SATA functions may be brought up and run to monitor for attachment detections, as represented in the detection sub-processes (subsets of steps) 410 and 420, to enable determination of orientation of the bridge device.

In the PCIe handling sub-process 410, the PCIe link initialization may be done in the initial step 412. In step 414, it may be determined if a particular event (e.g., PCIe configure request) occurs, indicating a host has been attached, to the present interface-side, via a PCIe connector. If not, the process loops back to step 412 (to continue waiting), otherwise the process proceeds to step 416. In step 416, the interface may be configured as a PCIe target (T). The process may then proceeds to step 418, in which SAS/SATA detection of the other side (interface) may be stopped, and a SAS/SATA initiator function is started. In other words, once it is determined that the present interface-side is the host-side, it may be configured as PCIe target and it may be presumed that the other interface-side would be configured as SAS/SATA initiator.

For the SAS/SATA handling sub-process 420, the SAS/SATA link initialization may be done in the initial step 412. In step 424, it may be determined if particular events (e.g., COMRESET/COMINIT) occur, indicating that a host is attached, to the present interface-side, via a SAS/SATA connector. If not, the process loops back to step 422; otherwise, it may be determined (in step 426) if a particular event (e.g., COMSAS) occurs, indicating SAS based connection. If no COMSAS occurs, the process may proceed to step 428, where (once a SATA link comes up, as only a host should initiate link-up) the present interface-side may be configured as SATA target. Returning to step 426, if COMSAS occurs, the process proceeds to step 430, where it may be determined whether an Identify frame, indicating initiator capabilities, is received. If so, the present interface-side may be configured as SAS target (using the received Identify frame), otherwise an error occurs. In step 434, once a SAS/SATA host is detected (and the present interface-side is configured accordingly—i.e., as SAS or SATA target), then the bridge device may assume the role of root complex on the PCIe interface—thus, the PCIe detection for the other interface-side may be stopped (if still running), and it may be configured as a PCIe initiator. In this regard, if a PCIe link is already up, a hot reset may be performed. Otherwise, the PCIe link may be brought up, and configuration of the attached PCIe device may be initiated. When the PCI configuration is done, a link reset may be performed on the SAS/SATA side so that the bridge device may re-negotiate the link and advertise the details of the target that it is emulating.

If a PCIe host is detected (e.g., in detection sub-process 410), then PCIe configuration may already be occurring, and as such the bridge device may be ready to advertise its capability structures and respond to configuration. To that end, the attached device may be preconfigured to specify the host controller to be utilized—e.g., whether it will use the NVMe, SOP/PQI, or AHCI host controller interface. Further, at this point, the SAS/SATA link is brought up (as initiator, on the other side) if it is not already up. Once the Identify frame has been received (if SAS) or the Identify Device Command has received a response (if SATA), the details of the attached device may be known, and a reset (specific to the specified host controller interface) may need to be issued (e.g., in the case of a hot plug).

In some implementations, bridge devices may be configured to use tri-mode serdes or phys, which may be capable of functioning as SAS/SATA or PCIe devices. In this regard, having two links capable of operating in accordance with SAS/SATA or PCIe may mean that the phy circuitry would have to report which mode it is operating in, and the interface configuration process described above may then be used in similar manner as when there is one phy in each mode.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for enhancing active link utilization for SAS topology.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form. Accordingly, some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method, comprising:
in a bridge device:
determining a type of a first interconnect corresponding to a first device;
determining a type of a second interconnect corresponding to a second device; and
controlling operation of the bridge device, based on the determined type of the first interconnect and the determined type of the second interconnect, by:
configuring a first interface in the bridge device for use in interacting with the first device, based on the determined type of the first interconnect;
configuring a second interface in the bridge device for use in interacting with the second device, based on the determined type of the second interconnect; and
configuring orientation of bridging performed in the bridge device, wherein configuring orientation of bridging comprises assigning different functions to the first interface and the second interface, based on the first device and the second device, respectively.

2. The method of claim 1, comprising configuring orientation of bridging such that the first interface and the second interface are assigned expected peer functions for each of the first device and the second device, respectively.

3. The method of claim 1, comprising assigning one of the first interface and the second interface a function of initiator and the other one of the first interface and the second interface a function of target.

4. The method of claim 1, comprising converting data communicated in the bridge device, between the first interface and the second interface, to match determined types for each of the first interconnect and the second interconnect.

5. The method of claim 1, wherein one of the first device and the second device comprises a host system and the other one of the first device and the second device comprises an add-in device.

6. The method of claim 5, wherein the add-in device comprises a storage device, attached internally or externally to the host system.

7. The method of claim 1, wherein each of the first interface and the second interface supports multiple types of interconnects.

8. A system, comprising:
one or more circuits for use in a bridge device, the one or more circuits are operable to:
determine a type of a first interconnect corresponding to a first device;
determine a type of a second interconnect corresponding to a second device; and
control operation of the bridge device, based on the determined type of the first interconnect and the determined type of the second interconnect, by:
configuring a first interface in the bridge device for use in interacting with the first device, based on the determined type of the first interconnect;
configuring a second interface in the bridge device for use in interacting with the second device, based on the determined type of the second interconnect; and
configuring orientation of bridging performed in the bridge device, wherein configuring orientation of bridging comprises assigning different functions to the first interface and the second interface, based on the first device and the second device, respectively.

9. The system of claim 8, wherein the one or more circuits are operable to configure orientation of bridging such that the first interface and the second interface are assigned expected peer functions for each of the first device and the second device, respectively.

10. The system of claim 8, wherein the one or more circuits are operable to assign one of the first interface and the second interface a function of initiator and the other one of the first interface and the second interface a function of target.

11. The system of claim 8, wherein the one or more circuits are operable to convert data communicated in the bridge device, between the first interface and the second interface, to match determined types for each of the first interconnect and the second interconnect.

12. The system of claim 8, wherein one of the first device and the second device comprises a host system and the other one of the first device and the second device comprises an add-in device.

13. The system of claim 12, wherein the add-in device comprises a storage device, attached internally or externally to the host system.

14. The system of claim 8, wherein each of the first interface and the second interface supports multiple types of interconnects.

15. An interconnect bridging system, comprising:
a first interface component that is configurable to support one or more types of interconnects;
a second interface component that is configurable to support one or more types of interconnects; and
a control circuit for controlling bridging operations, the controlling comprising:
configuring the first interface component based on a first interconnect type;
configuring the second interface component based on a second interconnect type, which is different than the first interconnect type; and
configuring orientation of bridging, the configuring of the orientation of bridging comprising assigning different functions to the first interface component and the second interface component.

16. The system of claim 15, wherein the control circuit is operable to assign one of the first interface component and the second interface component a function of initiator and the other one of the first interface component and the second interface component a function of target.

17. The system of claim 15, wherein the control circuit is operable to assign functions to each of the first interface component and the second interface component based on expected peer functions for each device attached to one of the first interface component and the second interface component.

18. The system of claim 15, wherein the control circuit is operable to convert data between the first interconnect type and the second interconnect type.

19. The system of claim 15, wherein the control circuit is operable to select the first interconnect type for the first interface component and/or the second interconnect type for the second interface component.

20. The system of claim 19, wherein the control circuit is operable to select each of the first interconnect type and the second interconnect type based on a type of interconnect used in a device attached to each of the first interface component and the second interface component, respectively.
